(19) United States
(12) Patent Application Publication
(10) Pub. No.: US 2010/0090802 A1
(43) Pub. Date: Apr. 15, 2010

(54) SENSOR ARRANGEMENT USING RFID UNITS

(76) Inventors: Hans-Erik Nilsson, Sundsvall (SE); Johan Sidén, Sundsvall (SE); Andrei Koptioug, Ostersund (SE)

Correspondence Address: VENABLE LLP, P.O. BOX 34385, WASHINGTON, DC, 20043-9998, US

(21) Appl. No.: 12/518,136

(22) PCT Filed: Dec. 7, 2007
(86) PCT No.: PCT/SE07/50960

§ 371 Date: Dec. 28, 2009

Related U.S. Application Data
(60) Provisional application No. 60/869,116, filed on Dec. 8, 2006.

(30) Foreign Application Priority Data
Dec. 8, 2006 (SE) 0602642-1

(51) Int. Cl. G06K 7/01; G06F 17/00; G06F 15/00

(52) U.S. Cl. 340/10.1; 235/375; 702/182; 101/483; 235/439

(57) ABSTRACT

A sensor arrangement suitable for determining a condition. A first RFID-unit and a second RFID-unit are subjected to the condition. The second RFID-unit is at least partly provided with a degradation unit having such properties that, when subjected to the condition, the second RFID-unit is functionally degraded to a greater extent than the first RFID-unit. A sensor arrangement product includes at least one sensor arrangement.

### TECHNICAL FIELD

The present invention relates to a sensor arrangement and sensor arrangement product for determining a state of condition in a surrounding of the sensor arrangement. The present invention also relates to a method for determining a state of condition in a surrounding of the sensor arrangement. The present invention relates to a computer program for performing the inventive method, a computer program product and a computer.

### BACKGROUND ART

Today there are various reasons to determine conditions at specific locations. For example, in some cases, it is of outmost importance to be able to determine whether a shipping package is subjected to internal moisture which may harm articles therein. Leakage of any chemical compound within closed containers is also of interest to detect so as to make it possible to take measures.

When it comes to constructions, such as buildings, it is today difficult to detect moisture within walls, floors and ceilings without actually cause damage to the “object” of interest.

### SUMMARY OF THE INVENTION

One aspect of present invention relates to the problem of determining a condition in a location where it is difficult to perform visual inspection.

Another aspect of the invention relates to the problem of determining a condition in a cost-effective way.

Yet another aspect of the invention relates to the problem of improving reliability of moisture detection.

Still yet another aspect of the invention relates to the problem of detecting leakage within walls, floors or ceilings of a construction, packing or goods. Leakage of water or other fluids or chemical compounds may go on during a long period of time when no visual inspection is possible, such as within walls of a house or with in a wrapped package provided on a loading pallet. Inspection of hidden leakages may be time and cost consuming. If a leak develops in a house wall, it can remain undetected for quite some time, in particular if the leakage is located under a floor.

These and other objects of the invention are achieved by a sensor arrangement suitable for determining a condition, for example moisture, comprising a first RFID-unit and a second RFID-unit being subjected to said condition. The sensor arrangement is characterized in that the second RFID-unit is at least partly provided with a degradation means having such properties that, when subjected to said condition, the second RFID-unit is functionally degraded to a greater extent than the first RFID-unit. This has the advantage of allowing determination of a condition in a location where it is difficult to perform visual inspection. Since the RFID-units are cheap a condition may be determined in a in a cost-effective way.

The degradation means may comprise a substrate including paper and/or fabric and/or plastics.

The degradation means may also comprise an RFID antenna whose properties are changed due to the condition to be determined. An RFID antenna may be designed to be particularly sensitive to a condition to be determined. There may be provided an ink which at least partly may be dissolved.

The degradation means may also comprise a discrete component whose properties are changed due to the condition to be determined and that is coupled to the RFID antenna.

The second RFID-unit may be substantially embedded within the degradation means. This may improve degradation of the second RFID-unit.

The sensor arrangement may further comprise a supporting device arranged to support the first RFID-unit and the second RFID-unit. This provides a more robust sensor arrangement

The supporting device may comprise a fastening means for attaching said arrangement to an object. This provides a user friendly means to attach the arrangement where suitable.

The first RFID-unit and the second RFID-unit may be arranged relative to each other such that, when activated, interference between said first RFID-unit and said second RFID-unit is at an acceptable level. In this way more reliable response signals may be achieved.

The first RFID-unit and the second RFID-unit may be arranged relative to each other such that said first RFID-unit and said second RFID-unit are subjected to substantially the same condition. This provides a more reliable determination of the condition.

Said condition may be at least one of the following: moisture, temperature, pressure, chemical contamination. It should be noted that a variety of application domains hereby is achieved.

The invention also relates to a sensor arrangement product comprising a set of sensor arrangements, said set of sensor arrangements (100) being removably connected to each other. This provides a user friendly tool for a user.

The set of sensor arrangements may be arranged in an N×M-matrix configuration, N and M being positive integers. The N×M-matrix may be an N×1-matrix or 1×M-matrix.

Advantageously said sensor is substantially flat and flexible, and the first and second sensor units may be substantially parallel to each other.

The degradation means may be an absorbent substrate comprising paper. The degradation means may also be part of the communicating antenna that changes properties due to the condition to be determined.

The degradation means may comprise an antenna geometry that changes antenna properties according to the condition.

The degradation means may comprise an antenna whose conductors change properties according to the condition.

The degradation means comprises an antenna that is connected to an electrical, mechanical or electromechanical component properties change according to the condition and thereby degrades the antenna.

The degradation means may be enhanced by letting both the first RFID unit and second RFID unit have antenna geometries that changes antenna properties according to the condition. In this way a power difference between the first sensor unit and the second sensor unit may be larger.

The first RFID-unit and the second RFID-unit may be arranged relative to each other such that their combined radiation patterns enhance the readability in certain directions.

Information may be stored in the information, provided at an object, about the materialistic properties inside the wall, such as presence of water pipes and its connections, electrical wires, beams, etc. Advantageously this information can be useful not only for determination of a specific condition but also for example to avoid damages when drilling in objects such as a wall.

A surprising benefit of sensor arrangement products according to the present invention is their ability to be produced in a streamlined, flexible shape. This facilitates production, for example, they can be produced using printing and/or laminating techniques. Other known manufacturing techniques can be employed, where suitable to the inventive sensor arrangement products. Installation of such sensor arrangement can also be done economically. Fitting devices can be provided on each sensor arrangement, for example, holes can be provided for affixing the device to a solid support. Alternatively, the device can be affixed by staples, screws, nails or similar directly through the device. Alternatively, adhesive can be used if configured in such a way as to not interfere with the function of the sensor arrangement. Both the flexibility of manufacture and the streamlined design allow for production of articles meeting a wide variety of size and shape demands.

Advantageously the method for determining a state of condition according to the invention may be implemented using either passive RFID-tags and/or semi-active RFID-tags.

The invention also relates to a communication device for determining a condition, for example moisture, comprising communication means for communicating with a sensor arrangement, and calculating means for determining the difference in performance of the first RFID-unit and the second RFID-unit, and means for establishing said condition. The communication device allows user friendly and remote determining means.

The communication device may further comprise means for determining a difference between a first response signal generated by the first RFID-unit and a second response signal generated by the second RFID-unit. This allows determination of a condition in a manner not requiring complex determining means.

The communication device may further comprise means for determining the difference between the activation energy of the first RFID-unit and the activation energy of the second RFID-unit. This allows determination of a condition in a manner not requiring complex determining means.

The communication device may further comprise means for presenting and/or storing the established condition.

The communication device may further comprise means for determining the distance between the communication device and an object, and/or means for optically identifying information provided at an object. In this way optimized signalling between the communication device and the arrangement may be achieved.

The invention also relates to a system comprising a sensor arrangement and a communication device.

The invention also relates to use of a communication device.

The geometrical design of antennas can also be made to be more sensitive to for example moisture. This can for example be made by having two or preferably several conducting lines close to each other. In a moisture environment there will be leakage current between the lines that will affect the antenna efficiency. The antenna can also incorporate discrete components that are sensitive to the condition to be determined. This can for example include resistors and capacitors sensitive to moisture and/or temperature and/or pressure.

The mentioned degradation means could also be designed to act in a reverse manner. That is, the design could be an antenna that improves its efficiency in proportion to the condition to be determined instead of receiving lower efficiency.

The substrate and/or antenna base could also be fabricated in a way that the substrate or base or parts of the same performs mechanical changes in its structure due to the condition to be determined in a way that changes the antenna properties. The mechanical changes could for example act as a switch over the antenna that closes or opens a part of the antenna, i.e. a 1-bit sensor telling on/off state or an analogue value in between. A material that expands due to raised temperature or moisture level could for example be applied under an antenna conductor in a way that it will break the conductor if the condition reaches a certain level. Reversely one could for example use a conductor material for the antenna or parts of it that has low conductivity in its original state and sinters and/or cures due to high temperature or other condition. Advantages includes a memory function in the way that even if the sensor unit has been exposed to said condition but the condition later returns to normal, one can still tell that the condition has occurred.

In order to determine several conditions at once there is an advantage of combining several sensor units into one. One RFID unit could for example be held as reference unit and not affected by the conditions to be determined and other RFID units could be designed to have degradation means for different conditions of interest to determine. An advantageous solution is to combine different sensor units that tells if a specific condition has occurred, i.e. 1-bit sensors where the occurred condition is read even if the condition is different at the time of read.

Other conditions that can be determined includes, but is not necessarily limited to, shock, vibrations, light (including UV and infrared), different kinds of radiation and different gases.

The invention also relates to a method for manufacturing a sensor arrangement product, comprising the step of printing and/or laminating said product by means of a properly equipped printing press

Additional objects, advantages and novel features of the present invention will become apparent to those skilled in the art from the following details, as well as by practice of the invention. While the invention is described below, it should be understood that the invention is not limited to the specific details disclosed. The above-mentioned skilled persons having access to the teachings herein will recognise additional applications, modifications and embodiments in other fields, which are within the scope of the invention.

### BRIEF DESCRIPTION OF THE DRAWINGS

For a more complete understanding of the present invention and further objects and advantages thereof, reference is now made to the following detailed description when read in conjunction with the accompanying drawings, wherein like reference characters refer to like parts throughout the several views, and in which:

FIG. 1a schematically illustrates a top view of a sensor arrangement, according to an embodiment of the invention;

FIG. 1b schematically illustrates a side view of a sensor arrangement, according to an embodiment of the invention;

FIG. 1c schematically illustrates a side view of a sensor arrangement, according to an embodiment of the invention;

FIG. 1d schematically illustrates a sensor arrangement product, according to an embodiment of the invention;

FIG. 1e schematically illustrates a sensor arrangement product, according to an embodiment of the invention;

FIG. 2a schematically illustrates a communication device, according to an embodiment of the invention;

FIG. 2b schematically illustrates a communication device and sensor arrangement, according to an embodiment of the invention;

FIG. 2c schematically illustrates a communication device and sensor arrangement, according to an embodiment of the invention;

FIG. 3a illustrates flow chart depicting a method for determining a condition, according to an embodiment of the invention;

FIG. 3b illustrates flow chart depicting a method for determining a condition, according to an embodiment of the invention;

FIG. 3c illustrates flow chart depicting an alternative method for determining a condition, according to an embodiment of the invention; and

FIG. 4 schematically illustrates an apparatus, according to an embodiment of the invention.

### DETAILED DESCRIPTION OF THE DRAWINGS

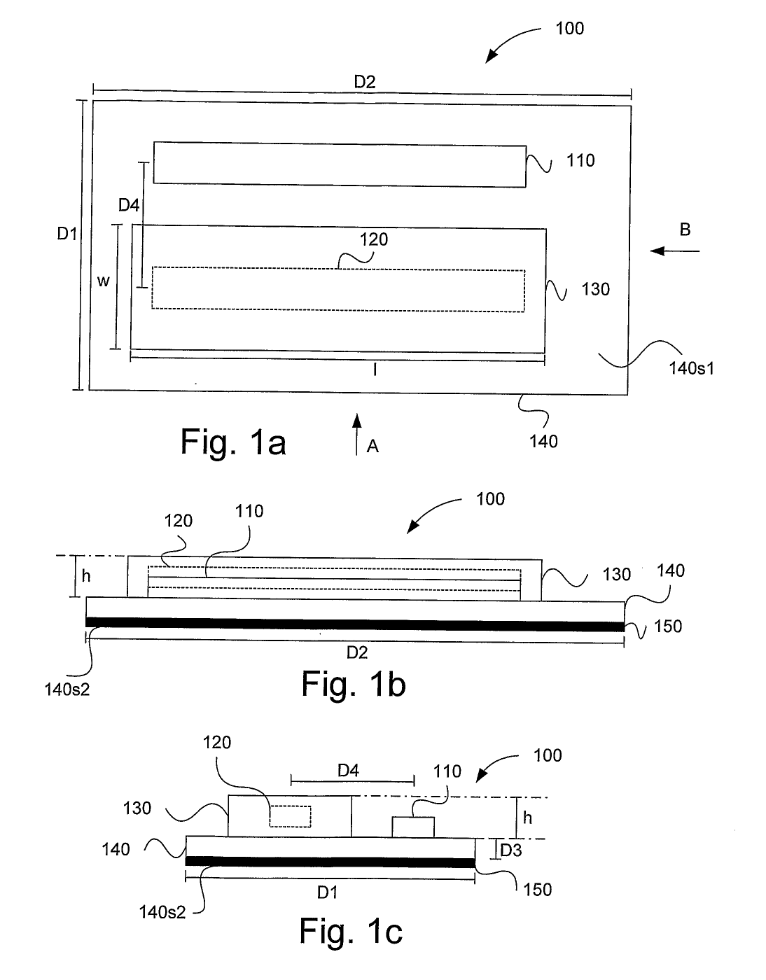

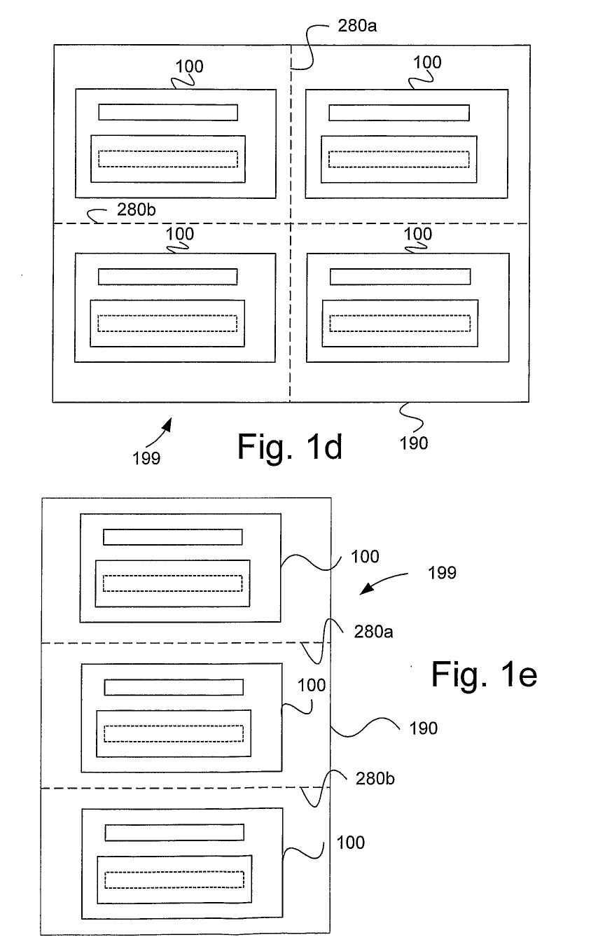

With reference to FIG. 1a there is illustrated a sensor arrangement 100 according to an aspect of the invention.

The sensor arrangement 100 comprises a sheet like base element 140. The base element has a first surface 140s1 and a second surface 140s2. The base element 140 may be composed of a variety of different materials. One suitable material is paper. Other suitable materials may be plastics, wood and textile, where the materials can be flexible or rigid, The base element 140 may also be composed of a mixture of different materials.

A first dimension of the base element is denoted D1. The value of D1 may be arbitrarily chosen. According to one embodiment D1 is chosen so that the sensor unit will not be bent when applied. According to one embodiment D1 is 5 cm.

A second dimension of the base element is denoted D2. The value of D2 may be arbitrarily chosen. According to one embodiment D2 is chosen so that the sensor unit will not be bent when applied. According to one embodiment D2 is 5 cm.

A first RFID unit 110 is attached to the first side 140s1 of the base element 140. The RFID unit 110 may comprise of an RFID chip electrically and/or electromagnetically coupled to an antenna. The RFID chip and antenna units can be mounted as one unit or as separate units. The antenna can for example be printed or etched with aid of electrically conductive material. The antenna can be directly applied to the base element 140 or be part of a secondary base in 110. 110 with chip and/or antenna can for example be attached with adhesive. 110 with chip and/or antenna can for example also attached using lamination technologies.

A second RFID unit 120 is attached to the first side 140s1 of the base element 140. The second RFID unit is substantially identical to the first RFID unit 110.

The first RFID-unit 110 is also referred to as a first RFID-tag. The second RFID-unit 120 is also referred to as a second RFID-tag.

According to one example the first and second RFID unit are arranged substantially parallel to each other, as illustrated with reference to FIGS. 1a and 1c. This is advantageous in terms of manufacturing the sensor arrangement 100. Also, by providing the first and second RFID unit in a parallel fashion separated by a predetermined distance unwanted interference between the first and second sensor unit may be reduced.

Radio-frequency identification (RFID) is a collection of technologies for remote identification of objects. The base systems consists of an RFID reader unit and identification unit commonly referred to as an RFID tag or transponder. The RFID tag is a unit of dimensional size from less than a millimeter to over one meter where the most common tags has dimensional size of 1 cm to 30 cm. RFID tags are commonly used as complements and/or replacers for barcodes. Advantages with RFID technology over barcodes includes that several objects can be identified simultaneously, there is no need for line-of-sight between reader and object and an RFID tag commonly store more data than barcodes. RFID is used for identifying objects in a wide variety of applications including identifying objects along logistics chains, animal and person identification and identifying cars for road tolling. Reading distances stretches from a few mm to several meters. RFID tags commonly comprise two main parts, a semiconductor device referred to as the RFID chip and an antenna. There also exists a technology referred to as chipless RFID that functions without a traditional RFID chip.

The most common RFID tags are referred to as passive tags. Passive tags do not incorporate its own power source but receives all energy necessary to operate from the interrogating radio signal. The communication back to the reader is at least in the UHF band (300 MHz to 3 GHz) band most commonly performed by backscattering, meaning that the tag does not retransmit actively but communicates by reflecting incoming signals. While some RFID tags can only be read, some can also be written to. Tags operating at UHF frequencies commonly have resonant antennas of size 0.1 to 2 wavelengths in at least one dimension while tags operating at lower frequencies usually uses inductive coupling.

Semi-active tags (also referred to as semi-passive) incorporate their own power supply in terms of internal battery, or similar, and often also incorporate more electronics than passive tags. Similar to passive tags, semi-active tags also communicates by backscattering. The property of internal energy source facilitates the use of sensor functionality and to provide functionality to log events over time. Advantages also include a longer maximum read range than reached with passive RFID tags.

At frequencies below the UHF band, passive tags are commonly inductively coupled with aid of at least one coil turn and preferably many since voltage induced due to an interrogating magnetic field is proportional to the number of turns and the frequency. The coils can be laid out a single or multiple layers and its properties can be enhanced by including a ferrite core. Common coils are circular (winded along a rod) or rectangular and has dimension in the order less than a centimeter to tens of centimeters.

If a ferrite core material would be sensitive to the condition to be determined it would degrade the antenna functionality and thereby the antennas ability to communicate. Alternatively, if the coil conductors were sensitive to the condition to be determined for example by a change in electrical conductivity it would also degrade the antenna functionality and thereby the antennas ability to communicate.

Antennas for tags operating at UHF frequency commonly have variants of dipole antennas or multilayer microstrip antennas but almost all known antenna types can be employed. Commonly found sizes are in the range of 0.1 to 2 wavelengths in at least one dimension.

If an RFID tag operating at UHF is embedded in a material that changes its electrical properties proportional due to the condition to be determined the condition will cause degradation to the embedded antenna of the tag in terms of dielectric losses and change of input impedance. The relative level of the condition to be determined can be measured for an RFID system by comparing the difference in RFID reader output power required to communicate with respectively an open and an embedded RFID tag exposed to the same surrounding condition. Without necessarily changing the reader output power, the difference in backscattered signal strength of an open and an embedded tag is also proportional to the condition to be determined and can be measured to determine the condition.

In a preferred embodiment, the RIFD tag antennas are also designed in a way that their sensitivity to a final background material is minimized. This reduces the risk of having different background properties for the two RFID units, i.e. one just in front of a nail but not the other and similar characteristics that would create unwanted degradation to the communication of one tag antenna but not to the other.

The second RFID unit 120 is at least partly embedded in a substrate 130. According to one example the second RFID unit 120 is completely embedded within the substrate 130. In this case the substrate 130 is attached to the base element 140. The substrate 130 may be attached by means of adhesive and/or lamination technologies and/or staples.

The substrate 130 may be composed of a moisture absorbent material such as paper, plastics, fabric, wood and/or mixtures of such materials.

Of course other configurations or orientations of the first and second RFID units may be implemented. For example, the first and second RFID units may be attached to the base element 140 in a V-formed shape. Alternatively, the first and second RFID units may be arranged in an L-formed shape. The first and second RFID units may be oriented in any preferred orientation along a 2-dimensional plane or by creating a 3-dimensional structure. However, in one embodiment the placement of the first and second RFID units on the base element should be such that unwanted interference is minimized and the size of the base element also is minimized.

An advantage of using more than one RFID unit comes from that the first and second RFID units can also be arranged so that interference between the two tags is beneficial, for example the radiation pattern and also for the mutual input impedance of the two antennas. The first and second RFID units may for example be oriented in a way that the radiation pattern created from the two RFID units enhances the maximum RFID read range in certain directions. In the common literature this kind of antenna arrangement is referred to as antenna arrays and is well-known to enhance communication in certain directions.

In some embodiments the first dimension D1 and the second dimension D2 of the base element are less important and placement of the first and second RFID units may be less constricted.

Dimensions of the components of the sensor arrangement may be chosen depending upon which particular use is intended. For example, the substrate 130 may be chosen in a variety of different sizes and shapes. The substrate 130 may be provided to embed the second sensor 120 completely, or in part.

The present invention is particularly well-designed for uses in which water (steam or liquid) are to be detected. This includes underground pipe applications which could involve sewage, which comprises predominantly contaminated water. Further, some applications may be directed to detect urine. Other applications include juices and emissions from food products such as juice formed from crushed or over-ripe fruit, containerized liquids such as alcohol or other drinks that are intended to be stored in a closed container but which containers can rupture or leak. Thus, an aspect of the invention is to be interpreted as a moisture or liquid detecting sensor, and not limited to any one particular type of moisture or liquid. The liquid may be a water-containing liquid.

Various concentrations of moisture that can successfully be detected vary on the size, configuration and output power of the RFID-units used. In highly sensitive applications, the moisture can be in the range where mould and putrefaction can start to appear, for example in the range of relative humidity of 70-100%. According to one embodiment extremely small amounts of moisture can be detected by the sensor arrangement. In preferred configurations, a sensor unit will provide information about moisture concentrations above 70% relative humidity.

Various configurations are contemplated based on the intended use. For example, the sensor arrangement can be provided to accompany shipment of goods which are sensitive to moisture, such as computer components, e.g. electrical components.

FIG. 1b schematically illustrates a side view of a sensor arrangement seen from the arrow A illustrated with reference to FIG. 1a.

There is illustrated an adhesive layer 150 being provided on the second surface 140s2 of the base element 140. The adhesive layer 150 may be composed of a glue or sticker.

The height of the substrate 130 is denoted height h. The height h may be arbitrarily chosen. According to one embodiment the substrate height h is in the order of 1-10 mm producing a relatively thin sensor unit that can be easily applied at narrow locations. According to another embodiment the substrate height h is 10-200 mm which often gives a higher degradation to the embedded RFID antenna when the substrate is subject to the condition to be determined than for thinner layers. The width of the substrate 130 is denoted width w. The width w may be arbitrarily chosen. According to one embodiment the substrate width w is chosen so that it covers/embeds the whole width of the RFID tag. According to another embodiment the substrate width w is chosen so that it extends the width of the RFID tag antenna so to cover most of the antenna's electromagnetic near field which is commonly a distance from the antenna in the order of 1/20 to ⅙ of the present wavelength. In a preferred embodiment the substrate width is chosen together with the distance D4 in a way that the first RFID unit has a minor interference from the substrate 130. The length of the substrate 130 is denoted length l. The length l may be arbitrarily chosen. According to one embodiment the substrate length l is chosen so that it embeds the whole length of RFID tag. According to another embodiment the substrate length l is chosen so that it extends the length of the RFID tag antenna so to cover most of the antenna's electromagnetic near field which is commonly a distance from the antenna in the order of 1/20 to ⅙ of the present wavelength. The substrate 130 may also be perforated in order to facilitate for example moisture or other substances to penetrate into the substrate and/or facilitate for moisture or other substances to penetrate into an RFID tag antenna sensitive to the condition to be determined.

A third dimension, which is the height, of the base element is denoted D3. The value of D3 may be arbitrarily chosen. According to one embodiment D3 is in the order of common paper materials and thin plastic materials, i.e. 50 to 1000 μm. According to another embodiment D3 is in the order of thicker paper materials such as for example card board and thicker plastics materials, not necessarily flexible, i.e. 1 to 200 mm. Advantageously the third dimension of the base element is relatively small compared to the first and second dimensions, which means that the base element is sheet-like.

It should however be noted that any of the components of the sensor arrangement may be non-symmetric, and thus have an irregular shape.

With reference to FIG. 1c there is illustrated a side view of the sensor arrangement 100 seen from the arrow B as illustrated with reference to FIG. 1a.

There is illustrated in the FIGS. 1a, 1b and 1c that the second RFID-unit 120 is completely embedded in the substrate 130 according to this embodiment. There is also illustrated that the first and second RFID-units are substantially flat.

With reference to FIG. 1d it is illustrated a sensor arrangement product 199 comprising four sensor arrangements 100. The sensor arrangements are provided on a base sheet 190 in the form of a 2×2 matrix, i.e. a matrix having 2 columns and 2 rows. The base sheet 190 may be composed by paper or any other suitable material, such as for example plastics or wood. The base sheet 190 may also be composed by a mixture of suitable materials.

According to this example there is provided two perforations 280a and 280b, respectively. A user may rip off one or more sensor arrangements by ripping off the base sheet 190 along at least a part of any of the perforations 280a or 280b. The base sheet 190 is advantageously made up from a flexible material. By having a flexible base sheet the sensor arrangement product 199 may be formed as a roll having a helix shaped form.

The sensor arrangements 100 may be detachably connected to the base sheet 190. A user of the sensor arrangement product 199 may thus detach one or more sensor arrangements from the sensor arrangement product 199 and place sensor arrangements 100 where appropriate, such as on a beam (baulk) in a house construction when building the house.

Thus, the sensor arrangement product 199 may be regarded as a product having an arbitrary number of “etiquettes” or “stickers” provided thereon. This enables a user friendly product for providing sensor arrangements to be attached to objects in adequate locations. Advantageously the sensor arrangements may be re-attached to the sensor arrangement product 199. The layer 150 has characteristics for allowing to easy detach the sensor arrangement from the sensor arrangement product 199, and to connect it to an object or surface.

With reference to FIG. 1e it is illustrated a sensor arrangement product 199 comprising three sensor arrangements 100 arranged in a 3×1 matrix, i.e. a matrix having 1 column and 3 rows. An advantage of this format (having only one column) is that it provides an improved possibility to manufacture the sensor arrangement product in a “roll-to-roll” procedure in a simple way. Thus simple manufacturing of the sensor arrangement product 199 is achieved. Of course, other formats are also suitable for manufacturing the sensor arrangement product in a “roll-to-roll” procedure, such as the 2×2 matrix format or a 2×3 matrix format.

Also this example embodiment of the sensor arrangement product 199 is provided with perforations 180a and 180b being suitable for facilitating ripping of the sensor arrangement product 199 in one or more pieces.

The sensor arrangement product 199 may be in any suitable form comprising an arbitrarily number of sensor arrangements 100. According to one embodiment the sensor arrangement product 199 comprises only one sensor arrangement 100. According to another embodiment the sensor arrangement product 199 is in the form of an N×M matrix, wherein N and M are positive integers. According to a particularly advantageous embodiment the sensor arrangement product 199 is in the form of a 1×M matrix, wherein M is a large positive integer, e.g. 100, 500 or 1000, or 10,000. In this latter case, where M is a relatively large integer, the sensor arrangement product 199 advantageously is in the form of a roll (helix).

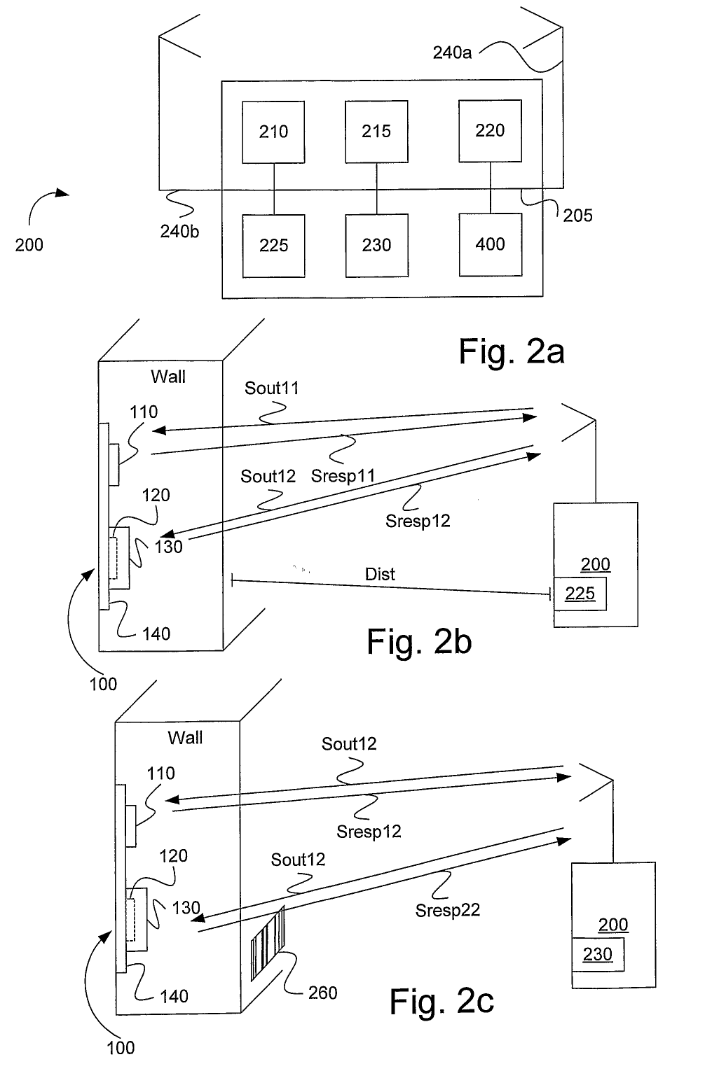

With reference to FIG. 2a there is schematically illustrated a communication device 200. The communication device 200 may also be referred to as reading device, measuring device or detecting unit. The communication device 200 comprises a power source (not shown) arranged to power up internal units, such as an apparatus 400 and a reading unit 220.

The power source may be one or more batteries. The communication device 200 also comprises means for generating output signals (not shown) as known in the art.

The communication device 200 is provided with a presentation unit 210. The presentation unit 210 may comprise any suitable visual presentation means, such as a display, e.g. an LCD display. Alternatively, the presentation unit 210 may comprise light emitting diodes, such as a set of diodes arranged to transmit either green, yellow or orange, or red light.

Additionally, the presentation unit 210 may comprise any suitable audio means, such as a loudspeaker. The audio means may be arranged to output information to an operator of the communication device 200 by means of e.g. a synthetic voice, or tone signals of different amplitude and frequency.

The communication device 200 is provided with an I/O- (input/output) unit 215. The I/O unit 215 may comprise a touch screen, key pad, key board, or any other suitable means for inputting/outputting data, such as command data. Usable techniques may involve one or more data ports such as USB or serial/parallel data. Also wireless techniques, such as WLAN, 3G, GPRS, GSM, SMS, MMS may be used. The presentation unit 210 and the I/O unit are arranged to allow an operator to interact with the communication device 200. The operator may control the communication device 200 so as to initiate and perform a process involving detection of a state of condition according to the invention. The operator may control the communication device 200 so as to present a result of the process involving detection of a state of condition, such as determining how the result is to be presented by the presentation unit, e.g. signaling by means of the diodes, displaying alpha numerical characters, graphics, or by outputting sounds indicating the state of condition.

The communication device 200 is provided with an antenna 240a for transmitting output signals Sout to a sensor arrangement 100. The communication device 200 is provided with an antenna 240b for receiving response signals from a sensor arrangement 100. The antenna 240a is arranged to transmit an output signal to the first RFID-unit 110. The antenna 240a is arranged to transmit an output signal to the second RFID-unit 120. The antenna 240b is arranged to receive a response signal sent from the first RFID-unit 110. The antenna 240 is arranged to receive a second response signal sent from the second RFID-unit 110. Alternatively, the communication device 200 is provided with only one antenna having the functionality of transmitting output signals to the first RFID-unit 110 and the second RFID-unit 120. The single antenna is also arranged to receive response signals from both the first RFID-unit 110 and the second RFID-unit 120.

The communication device 200 is here illustrated being provided with the reading unit 220. The reading unit 220 is arranged to determine characteristics of response signals sent from the first RFID-unit 110 and the second RFID-unit 120. The response signal characteristics may comprise parameters such as response signal amplitude, response signal frequency, response signal phase, and ID numbers associated with any RFID-unit. Other examples of parameters may be direct information about the condition to be determined, for example by means of information in additional side-bands in the signal. Information in additional sidebands may for example be transmitted by letting the side band have a frequency offset to the original carrier that is proportional to the condition to be determined. A sideband may also have an amplitude that that is proportional to the condition to be determined. The reading unit 220 may also be arranged to determine a characteristics of any output signal. The output signal characteristics may comprise parameters such as output signal amplitude, output signal frequency, etc.

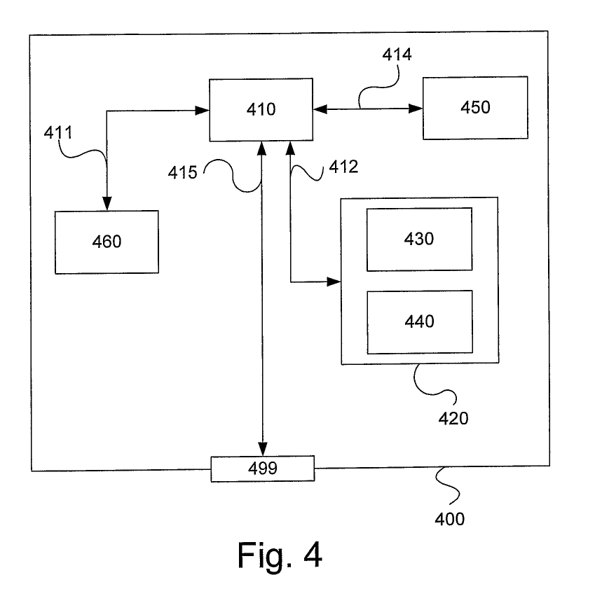

The communication device 200 is provided with a processing unit 400. The processing unit is depicted in greater detail with reference to FIG. 4. The processing unit 400 is arranged to receive the information read by the reading unit 220. Typically the read information is processed so as to determine a state of condition provided in the proximate surroundings of a sensor arrangement 100. According to one example the read information is processed so as to determine a degree of moisture, or a concentration regarding a predetermined chemical compound, provided in the proximate surroundings of a sensor arrangement 100. The processing unit 400 is thus arranged to process said read information so as to determine a state of condition associated with the environment surrounding of the sensor arrangement 100. The state of condition may be determined by calculating (by using output signal characteristics) a difference in activation energy between the first and second RFID-unit and comparing this difference with a set of predetermined activation energy differences so as to identify a corresponding state of condition. Alternatively, the state of condition may be determined by calculating (by using response signal characteristics) a degree of degradation of the first and second RFID-unit, identifying a difference thereof, and comparing this difference with a set of predetermined degradation differences so as to identify a corresponding state of condition.

The communication device 200 is provided with a distance determining unit 225. The distance determining unit 225 is arranged to determine a distance between the communication device 200 and a predetermined object, such as a wall containing one or more sensor arrangements 100, or, when applicable, a distance between the communication device 200 and a sensor arrangements 100. This may be performed by any suitable means known in the art, such as by means of a reflecting laser beam, ultrasonic sound, radio waves, radar technology, or other.

The communication device 200 is provided with a visual recording unit 230. The visual recording unit 230 is arranged to record an external piece of information being associated with one or more sensor arrangements. The external piece of information may be a 2-Dimensional graphical code, such as a bar code or alphanumerical information provided in the vicinity of one or more sensor arrangements. The external piece of information is referred to as information 260. The information 260 may comprise information about the location of the 2-Dimensional graphical code, and thus indirect the actual location of a sensor unit of interest. Additionally, or alternatively the information 260 may comprise information about the condition the sensor unit is primarily designed to determine. Additionally, or alternatively the information 260 may also comprise information about what radio technology that the sensor unit is preferably operated with. Additionally, or alternatively the information 260 may also comprise information about the properties of its sometimes hidden vicinity, such as water pipes and its connections, electrical wires, beams, etc. Information about the sensor unit's proximity through the information 260 may also be of advantage when the sensor unit as such is not used to determine a condition, for example to avoid damages by drilling in objects. The visual recording unit 230 is arranged to determine the content of the information 260 and transmit the content to the processing unit 400 for storage and processing thereof. The content of the information 260 may be subsequently sent to external, central databases. The visual recording unit 230 may be a camera provided with a digital image processing means for processing images so as to identify a content of the 2-Dimensional graphical code.

An internal link 205 is arranged to electrically interconnect the internal units 210, 215, 220, 225, 230 and 400 with the first and second antennas 240a and 240b. Two or more sub-units of the communication device 200 may be integrated or combined with each other.

The communication means 200 may be a hand-held device. Advantageously the size and weight of the communication means 200 is such that it is easy to carry and operate by an operator, i.e. a user of the communication device, such as a building moisture inspector.

FIG. 2b schematically illustrates the communication device 200 and the sensor arrangement 100 being located within a wall in a building. There is illustrated that the communication device 200 in this example has one antenna for both transmitting and receiving signals. This is a set-up for use of semi-active or passive RFID-units. It is here assumed that a degradation of the second RFID-unit is larger compared to the first RFID-unit.

The communication device 200 is arranged to transmit an output signal Sout to the first RFID-unit 110 and the second RFID-unit 120. This output signal Sout has a certain amplitude. If the energy of the transmitted signal is above an activation energy level of the first RFID-unit, the first RFID-unit will be activated and generate and transmit a response signal to the communication device 200. If the energy of the transmitted output signal Sout is not above the activation energy level of the first RFID-unit no response signal will be generated and transmitted to the communication device 200. The communication terminal 200 is arranged to increase signal strength of the output signal Sout until a response signal Sresp11 will be received by the communication terminal 200. It is then determined required activation energy of the first sensor unit 110. The same procedure is performed so as to determine required activation energy of the second sensor unit 120. As a response to the received output signal Sout11 the first RFID-unit 110 generates a response signal Sresp11, which is transmitted to the communication unit 200. As a response to the received output signal Sout12, having a signal strength sufficient to activate the second sensor unit 120, the second RFID-unit 120 generates a response signal Sresp12, which is transmitted to the communication unit 200.

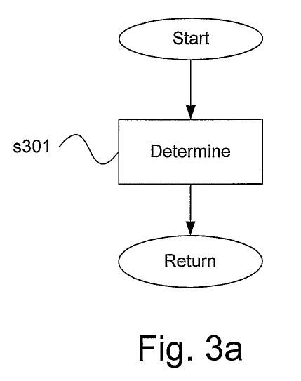

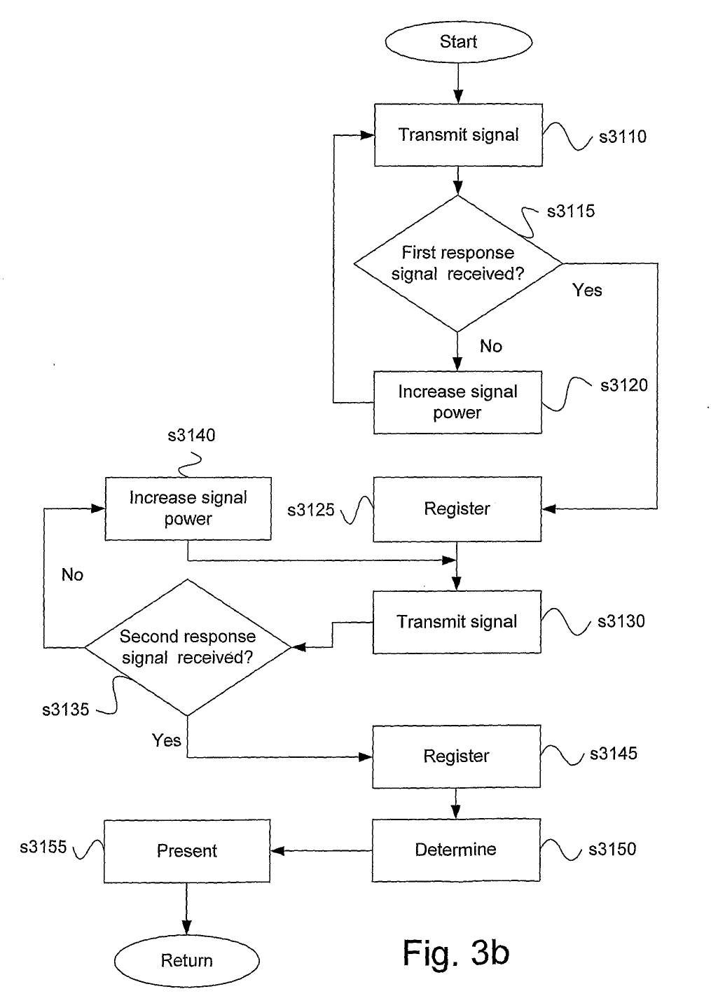

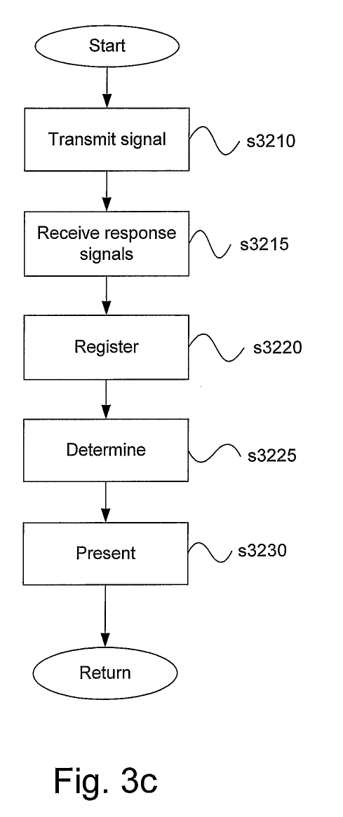

A method according to what is generally depicted with reference to FIG. 2b is depicted in greater detail with reference to FIG. 3b.

A distance Dist between the communication device 200 and the wall is illustrated. As depicted above the distance determining unit 225 is arranged to determine the distance Dist. This distance may be used when determining a difference in performance of the first RFID-unit and the second RFID-unit, and establishing said condition on the basis of said determined difference.

Moisture sensing label incorporating two RFID tags where one of the tags is covered with a moisture absorbing material, for example paper based. In a humid environment the antenna of the embedded tag gets less efficient and needs a stronger RF signal to operate. The difference in required power to operate is proportional to the humidity level.

FIG. 2c schematically illustrates the communication device 200 and the sensor arrangement 100 located within a wall in a building. This is a set-up for use of semi-active or passive RFID-units. According to this example, the communication device 200 is transmitting an output signal Sout12 having a predetermined amplitude. In response to receiving the output signal Sout12 each of the first and second RFID-unit is powered up by means of their respective battery or interrogating RF signal and transmits a response signal to the communication device 200. The first sensor unit 110 transmits a first response signal Sresp12 having a first amplitude to the communication device 200. The second sensor unit 120 transmits a second response signal Sresp22 having a second amplitude to the communication device 200. If the second sensor unit is functionally degraded to a greater extent than the first RFID-unit 110 there is a difference in signal strength between the first and second sensor unit. Based upon this difference a condition may be established according to the invention.

A method according to what is generally depicted with reference to FIG. 2c is depicted in greater detail with reference to FIG. 3c.

The visual recording unit 230 is illustrated. The recording unit 230 is arranged to record an external piece of information 260 provided on the wall. This information may be optically detected and used for various purposes, such as identify at what location a sensor arrangement is provided, e.g. in a particular wall of a building. Statistics data may be collected and stored in the communication device 200 for allowing an operator to follow trends of degradation of one or more sensor units. Information may also be stored in the information 260 about the materialistic properties inside the wall, such as presence of water pipes and its connections, electrical wires, beams, etc. Advantageously this information can be useful not only for determination of a specific condition but also for example to avoid damages when drilling in objects such as a wall.

FIG. 3a illustrates a flow chart depicting a method for determining a condition, according to an embodiment of the invention. The method for determining a condition, for example moisture, comprises the steps of:
determining a difference in performance of a first RFID-unit and a second RFID-unit, said first RFID-unit and said second RFID-unit being subjected to said condition, the second RFID-unit being functionally degraded to a greater extent than the first RFID-unit due to said condition; and
establishing said condition on the basis of said determined difference.

The step of determining the difference may comprise the step of determining a difference between a first response signal generated by the first RFID-unit and a second response signal generated by the second RFID-unit. The difference between the first response signal and the second response signal may be based upon the amplitude of said signals.

The step of determining the difference may comprise the step of determining the difference between the activation energy of the first RFID-unit and the activation energy of the second RFID-unit.

The method may comprise the step of presenting and/or storing the established condition.

FIG. 3b illustrates a flow chart depicting a method for determining a condition, according to an embodiment of the invention, wherein passive or semi-active RFID-units may be used.

In a first step s3110 the communication device 200 is transmitting an output signal from having a predetermined signal strength to a first RFID-unit 110 and a second RFID-unit 120. The step s3110 is followed by a step s3112.

In the step s3115 it is determined whether a first response signal has been received. If the first response signal has been received a subsequent method step 3125 is performed. If the first response signal has not been received a subsequent method step 3120 is performed.

In the method step s3120 an incremental increase of output signal amplitude is performed. The step s3120 is followed by the step s3110. This means that, in practice, the level of output signal strength is increased until a first response signal is received from the sensor arrangement by the communication device 200.

In the step s3125 it is registered information about an activation energy of the sensor unit which sent the first response signal. The step s3125 is followed by a step s3130.

In the step s3130 the communication device 200 continues to transmit an output signal to a first RFID-unit 110 and a second RFID-unit 120. The step s3130 is followed by a method step s3135.

In the method step s3135 it is determined whether a second response signal has been received. The second response signal is sent from an RFID-unit other than the one transmitting the first response signal. If the second response signal has been received a subsequent method step 3145 is performed. It should be noted that the first and second sensor units may transmit response signals at the same time, i.e. when the signal strength of the output signal Sout is above the activation energy of the first and second sensor units, respectively. If the second response signal has not been received a subsequent method step 3140 is performed.

In the step s3140 an incremental increase of output signal amplitude is performed. The step s3140 is followed by the step s3130. This means that, in practice, the level of output signal strength is increased until a second response signal is received from the sensor arrangement by the communication device 200.

In the step s3145 it is registered information about an activation energy of the sensor unit which sent the second response signal. The step s3145 is followed by a step s3150.

In the step s3150 there is determined a condition of a surrounding of the first and second sensor units 110 and 120. According to one example the condition may be a degree of moisture. Basically, there is determined a difference between required activation energy of the first and second RFID-unit. The relative difference of activation energies is proportional to a degree of moisture in the surrounding of the first and second sensor units 110 and 120. Determination of the condition may be performed in various ways. One way to determine the condition is to perform a look-up process wherein, in this case, said relative difference between activation energies is corresponding to a certain predetermined, pre-stored degree of moisture value. For example, a relative difference of activation energies of at about 0.1 to 10 dB may correspond to a degree of moisture of 70-100% relative humidity or a certain degree of wetness. The step s3150 is followed by a step s3155.

In the step s3155 a relevant piece of information is presented. An example of relevant information may be the determined moisture value or level of wetness or any information that may indicate the condition in a surrounding of the first and second RFID-units 110 and 120. The relevant information may be presented by the presentation unit 210. According to one example, the communication device 200 is provided with a set of diodes arranged to transmit green, yellow, orange, or red light depending upon the determined state of condition. For example, if a degree of moisture is above 90%, red light will be transmitted. If a degree of moisture is in the interval 80-90%, orange or yellow light will be transmitted. If a degree of moisture is below 80%, green light will be transmitted. Thereafter the method ends.

According to one embodiment the same result may be achieved by starting transmitting the input signal at a relatively high power level and thereafter performing a similar procedure as depicted above by reducing the power of the input signal. According to this alternative events are registered in reversed order.

FIG. 3c illustrates a flow chart depicting a method for detecting a state of condition, according to an embodiment of the invention, wherein passive or semi-active RFID-units are used. The method for detecting a state of condition may be a method for detecting a degree of moisture in a surrounding of the first and second sensor units 110 and 120.

In a first step s3210 an output signal Sout12 having a predetermined amplitude is transmitted from the communication device 200 to the first and second RFID-unit. The step s320 is followed by a step s3215.

In the step s3215 a first response signal Sresp12 is received by the communication device 200. The first response signal Sresp12 is generated by and sent from the first RFID-unit 110. A second response signal Sresp22 is received by the communication device 200. The second response signal Sresp22 is generated by and sent from the second RFID-unit 110. The step s3215 is followed by a method step s3220.

In the method step s3220 an amplitude of the first response signal Sresp12 is registered. Further, an amplitude of the second response signal Sresp12 is registered. The step s3220 is followed by a step s3225.

In the step s3225 there is determined a condition of a surrounding of the first and second sensor units 110 and 120. According to one example the condition may be a degree of moisture. Basically, there is determined a difference between the amplitudes of the received first response signal Sresp12 and the second response signal Sresp22. This relative difference in energy is proportional to a degree of moisture in the surrounding of the first and second sensor units 110 and 120. Determination of the condition may be performed in various ways. One way to determine the condition is to perform a look-up process wherein, in this case, said relative difference of response signal energy content is corresponding to a certain predetermined, pre-stored degree of moisture value. For example, a relative difference of response signal energy content of about 0.1 to 10 dB may correspond to a degree of moisture of 70-100% relative humidity or a certain degree of wetness. The step s3225 is followed by a step s3230.

In the step s3230 a relevant piece of information is presented. An example of relevant information may be the determined moisture value or any information that may indicate the condition in a surrounding of the first and second RFID-units 110 and 120. The relevant information may be presented by the presentation unit 210. Thereafter the method ends.

With reference to FIG. 4, a diagram of one embodiment of an apparatus 400 is shown. The apparatus 400 is also referred to as processing unit, as depicted with reference to FIG. 2a. The above-mentioned communication device 200 may include the apparatus 400. The apparatus 400 comprises a non-volatile memory 420, a data processing device 410 and a read/write memory 450. The non-volatile memory 420 has a first memory portion 430 wherein a computer program, such as an operating system, is stored for controlling the function of the apparatus 400. Further, the apparatus 400 comprises a bus controller, a serial communication port, I/O-means, an ND-converter, a time date entry and transmission unit, an event counter and an interrupt controller (not shown). The non-volatile memory 420 also has a second memory portion 440.

A computer program comprising routines for carrying out processing and analysis of registered activation energies of the first and second RFID-units is provided. A computer program comprising routines for carrying out processing and analysis of registered response signal amplitudes of the first and second RFID-units is provided. The programs may be stored in an executable manner or in a compressed state in a memory 460 and/or in read/write memory 450. The data processing device 400 may be, for example, a microprocessor.

When it is described that the data processing device 410 performs a certain function it should be understood that the data processing device 410 performs a certain part of the program which is stored in the memory 460, or a certain part of the program which is stored in the read/write memory 450.

The data processing device 410 may communicate with a data port 490 by means of a data bus 415. The non-volatile memory 420 is adapted for communication with the data processing device 410 via a data bus 412. The separate memory 460 is adapted to communicate with the data processing device 410 via data bus 411. The read/write memory 450 is adapted to communicate with the data processing device 410 via a data bus 414.

When data is received on the data port 499 it is temporarily stored in the second memory portion 440. When the received input data has been temporarily stored, the data processing device 410 is set up to perform execution of code in a manner described above. According to one embodiment, information signals received on the data port 490 comprises information generated by the reading unit 220. This information can be used by the apparatus 400 so as to determine a state of condition in a surrounding of the first and second RFID-units.

Parts of the methods described herein can be performed by the apparatus 400 by means of the data processing device 410 running the program stored in the memory 460 or read/write memory 450. When the apparatus 400 runs the program, parts of herein described methods are executed.

The following subject matter, which is intended to be patent sought, relates to the subject-matter as depicted in the manuscript “Remote Moisture Sensing Utilizing Ordinary RFID Tags” by Johan Sidén et al. The patent claims concerns a device for measurement of moisture (or other quantity suitable for the proposed technique) which in addition to the measured value also provides the exact position of the measurement. This particular feature is obtained by utilizing RFID technology in the measurement. In FIG. 1 a schematic picture of the preferred embodiment of the measurement device is presented. Even though the description in FIG. 1 relates to measurement of moisture the same technique can be used to measure other parameters i.e. everything that changes the efficiency of an RFID antenna can be measured using the proposed sensor concept. For example the technique will work well for the detection of temperature, gas concentration (e.g. H₂S), humidity and mechanical deformation.

In order to measure a specific quantity the antenna of the RFID tag needs to be arranged in such way that the antenna function is degraded as it is exposed to the quantity of interest. An RFID antenna made out of a material that increases its resistance with the temperature can be used to measure the temperature, since the RFID antenna function will degrade as the resistance increases with the temperature. The RFID antenna can also be affected by the material in the antennas near field region. The influence by the material close to the antenna can be used to design a sensor that measures a certain quantity according to the operation principle of the innovation.

The read-out of the sensor data may be done by sweeping the RFID readers output power from its maximum value towards lower power values. The output power levels where the different RFID tags included in the sensor are no longer responding is recorded. The measured sensor value is then extracted from the difference between the power levels demanded to read the two RFID tags. The sensor data can then be transformed into any desired unit using a look-up table or a relevant mathematical expression.

According to an aspect of present invention the proposed sensor device has the following characteristic features:
Two passive or semi-active RFID tags are placed in a construction where the relevant quantity (for example moisture, temperature, chemical concentration etc) should be measured. The measurement point can for example be within a wall of a building or within a package solution for logistics. A semi-active RFID-tag has a battery, but is also able to communicate by back scattering of the reader's radio signal. It does not have a radio and therefore does not transmit radio signals.
One of the RFID tags has an antenna that is designed in such way that its antenna function is degraded when it is exposed to the quantity it is designed to measure and the other RFID tag has an antenna that is essentially unaffected (or not affected in a significant way) by the same quantity.

The measured quantity is read-out from the sensor device by the difference or ratio of the power levels needed to read the different RFID tags within the sensor structure.

The proposed sensor device has the following advantageous properties:
provides a contact less measurement at a well defined location;
provides a digital number as an address to the measurement point which is transmitted over a wireless link during the measurement;
makes it possible to repeat a measurement at different points in time without uncertainty regarding the location of the measurement point;
in the case the sensor device is based on passive RFID tags there is no battery or other energy sources needed at the measurement point;
by using two RFID tags in the sensor device we obtain redundancy and fault tolerance in the ID signaling for the sensor;
by using two RFID tags per sensor the measurement becomes insensitive to the exact position of the reader device with respect to the sensor itself;
the proposed device has clear cost advantages since any standard RFID chip can be used without modification of the silicon chip.

Abstract—The paper presents a concept where pairs of ordinary RFID tags are exploited for use as remotely read moisture sensors. The pair of tags is incorporated into one label where one of the tags is embedded in a moisture absorbent material and the other is left open. In a humid environment the moisture concentration is higher in the absorbent material than the surrounding environment which causes degradation to the embedded tag's antenna in terms of dielectric losses and change of input impedance. The level of relative humidity or the amount of water in the absorbent material is determined for a passive RFID system by comparing the difference in RFID reader output power required to power up respectively the open and embedded tag. It is similarly shown how the backscattered signal strength of a semi-active RFID system is proportional to the relative humidity and amount of water in the absorbent material. Typical applications include moisture detection in buildings, especially from leaking water pipe connections hidden beyond walls. Detection is performed by periodical scanning of RFID tags applied at known spots inside walls and similar. Presented solution has a cost comparable to ordinary RFID tags, and the passive system also has infinite life time since no internal power supply is needed. The concept is characterized for two commercial RFID systems, one passive operating at 868 MHz and one semi-active operating at 2.45 GHz.

### I. Introduction

THE desire to remotely identify objects, beyond the limitations of traditional barcodes, has driven research and development to produce Radio Frequency IDentification (RFID) tags at an extremely low cost. Passive RFID tags are for example commonly used as complement to barcodes on package labels since they are often easier to read than the barcode. RFID tags store more information and in some cases can also be written to. To our knowledge it does however not yet exist any low cost passive RFID chips that include an input port also for sensor data, i.e. an extra digital or analogue input port. The analogue version could for example measure the resistance over the sensor port, allowing for simple passive sensor elements that changes resistance proportional to the physical quantity of interest. One application where this would be valuable is remote measuring of moisture or wetness level at the location of the tag. A moisture sensor tag could for instance be positioned inside a wall or a floor in a building. The humidity level inside the wall could be read by holding a handheld RFID reader say one meter from the wall provided that the positions of the tags are discretely marked or mapped. By periodically reading the tags one can thus prevent costly damages due to mould or putrefaction. The tag could with advantage be positioned directly underneath hidden water pipe connections for early leakage detection.

Existing technologies for remote reading of humidity levels in hidden locations like such as inside walls are based upon different microwave technologies. For some locations and especially thick multilayer walls it can however be difficult to accurately read a moisture value. Proposals for in-situ water content sensors have also been made utilizing SAW-based transponders.

With the lack of mentioned RFID chips with sensor input, this paper presents an alternative approach of utilizing ordinary low cost RFID tags as moisture sensors, without adding extra cost in terms of additional electronics. Suggested concept is based upon using two tags on one label, separated so that the near-fields of their antennas do not interfere.

It is well known that the performance of low cost tags, constructed with simple one-layer antennas, is very sensitive to the surrounding environment and especially to nearby metallic surfaces and water. Water content nearby an RFID antenna will directly cause ohmic losses in the antennas near-field and also change its resonance frequency. It has previously been characterized how this property can be used to measure wetness in soil and snow by connecting a transmission line to a buried monopole antenna.

If considering proposed sensor arrangement with reference to FIGS. 2b and 2c, one of the RFID tags is covered or totally embedded with a moisture absorbing material while the other tag is left untouched. Paper material is known to withdraw water and water concentration in a paper material may be depicted as a function of relative humidity in surrounding air. In a humid environment the humidity concentration will thus be higher in the moisture absorbing material than in the vicinity of an open tag. There is provided a hysteresis effect that can indeed be a problem when moisture content in paper is used for measuring humidity levels. As water will increase both the real and imaginary parts of the paper's dielectric constant, the tag antenna will operate with lower efficiency due to ohmic losses and change in input impedance.

If the tags are passive, an RFID reader, such as communication device 200, held at the same distance from both tags in the label thus need to emit a stronger interrogating signal in order to power up the embedded tag than the naked tag. By comparing the minimum power levels required to power up each tag it is therefore possible to determine the humidity level at the tag's location. The procedure requires a lookup table where moisture levels previously have been characterized versus differences in power up levels.

This paper shows how such characterization can be conducted.

Moisture measurement by embedding an RFID tag could theoretically be done also with only one tag but that would require that the distance between the reader and the tag is always exactly the same. A normalizing measurement would also be needed at the time of installation to take into account the specific losses of the specific construction materials between the tag and reading location. Using only one tag would therefore be very difficult since it would only rely on absolute power values for one tag and not the difference between two tags.

Proposed label is characterized for a commercial passive RFID system classified as Generation 2 and operating in the license free EU band at 865-868 MHz. The concept is also characterized for a system using semi-active tags at 2.45 GHz. The semi-active tags incorporate a long-life battery and thus don't need to be remotely powered. Instead of comparing required power-up levels, the reflected signal strengths back to the reader are therefore monitored and compared.

The paper shows that relative humidity levels just over the normal 40-60% are measurable with suggested technique, but requires electronics that can properly distinguish between, or measure, power levels less than 1 dB. Power differences of several dBs are on the other hand observed for powering pairs of passive tags when reaching humidity levels of up to 80-90%. It is also shown how the semi-active system on the other hand actually presents an increased strength in its backscattered signal for an increased humidity.

The sensor labels are also characterized for when the absorbing material is directly supplied with several grams of water. Different setups are compared for the sensor tag when it is covered with different thicknesses of the absorbing material and for the passive solution also when the tag is covered with moisture absorbing material both in front and behind its antenna. The semi-active system is further characterized with an alternative absorbing material to see if there is a difference in using other paper based materials.

### II. Experimental Setup

Two passive Gen-2 tags from Alien Technology Corp. were placed on a 2.5 mm thick sheet of High Density PolyEthylene (HDPE) with dielectric constant and loss tangent of respectively about 2.25 and 0.03. The tag antennas' outer dimensions are 95×8 mm and the tags were separated 206 mm center to center. In three different setups, 10 stacked sheets of blotting papers made out of bleached kraft pulp with a basis weight of 260 g/m², measuring 103×20×5 mm, were placed respectively in front, behind and both in front and behind one of the tags. The other tag on the same label, 206 mm away, is left open. The experimental labels comprising the PEHD, tags and the blotting papers were put in a climate room where temperature and humidity are strictly controlled variables. An RFID reader antenna was also placed in the room and positioned symmetrically 1.47 m from the RFID label so that the reader antenna had exactly the same distance to both RFID tags within the label. The climate room itself measures 2.7×3.6 m. The reader antenna was connected to an RFID reader from SAMSys Technologies Inc, operating at 865-868 MHz and placed outside the climate room. The SAMSys RFID reader allows control of the antenna output power why it is possible to easy find a threshold level for what output power is necessary to remotely power up the individual RFID tags within the labels.

In an environment with 50% relative humidity (RH) at 23° C. it was found that for the specific range, the open tag needed an output power of about 16 dBm to power up and backscatter its ID number. At 50% and 23° C. there was also no measurable difference in power up levels for the tags covered with paper material as compared to the open tags. It was however observed that some tags always needed about 1 dB more to power up than other samples in exactly the same setup. The deviations due to different efficiency in the RFID chips have been adjusted for in the presented results. For a commercial product it is demanded that all tags require exactly the same operating power. The accuracy of presented measurements is in the order of 0.5 dB. When the relative humidity is increased the minimum power required to read the embedded tag is subtracted from the minimum power required to read the open tag. Calculated differences at specific humidity levels are recorded and can later be used to lookup humidity levels when measuring differences in power levels for the tags within the label placed at hidden locations.

One semi-active tag from TagMaster AB was similarly attached in the center of a sheet of PEHD. The semi-active tags differ from tested passive tags in several ways. Semi-active here means that the tag holds an internal energy source in terms of a conventional Lithium battery. With the battery operating the tag electronics there is no need to extract power-up energy from the interrogating signal of the RFID reader. To save energy and thereby increase the life time of the semi-active tags they do not actively retransmit ID-signals but utilize backscattering for communication, just like the passive systems. Tested semi-active RFID tags' antennas are also built as patch antennas on a low-loss PCB with its own ground plane. The patch antenna makes the tag almost totally insensitive to underlying material why the semi-active tags were only characterized with the blotting paper in front of them. The semi-active system operates at 2.45 GHz, a frequency where water is known to have high absorption of radio waves. The semi-active tag measure 85×54 mm and was covered with respectively 2.5 mm and 5 mm of blotting paper from sheets of size 90×58 mm. The TagMaster RFID antenna and reader is built in one unit why the reader electronics is now also inside the climate room. The current reader setup did not allow an easy control of output power like the case with the passive tag reader. However, it did allow direct readout of backscattered signal strength. Since this is the total received strength the investigation could only be made for one tag at the time and not for pairs of tags. The concept is however directly applicable for pairs of tags if one construct a reader that extracts individual received power, or controls the output power. The difference in backscattered power is now extracted from the same tag when open and covered with blotting paper and not for two simultaneously backscattering tags.

There are applications where pure wetness is of more importance than relative humidity. For such cases the same labels are also characterized when water is directly applied onto the embedding material. Water drops are added 1 gram at the time with aid of pipette and distributed as about 5 drops per gram over the blotting papers. Measurements are conducted about 2 minutes after appliance. Although 1 gram is not applied at only one spot on the blotting papers, the method of appliance and time between appliance and measurement gives a non-uniform water distribution within the volume of the blotting paper. This is especially true when comparing to the climate chamber experiments where the blotting paper samples are left for 24 hours before measurements take place.

### III. Power Differences Between Open and Embedded Tags in a Humid Environment

The climate chamber is kept at constant temperature 23° C. while the relative humidity is swept in discrete steps from 50% to 90%. For each increase step in the climate chamber the labels were left in the chamber for 24 hours in order to stabilize and evenly distribute moisture within the blotting paper. There may be presented the differences in reader output power that is necessary to power up the two passive tags at different levels of embedding one of the tags. One of the tags is embedded with 10 sheets of blotting papers in front of it and also a total embedding with 10 sheets in front and 10 sheets behind the tag. 10 sheets correspond to a thickness of about 5.2 mm. It may be realized that the more embedded tag is more sensitive to the surrounding humidity. The larger total volume of absorbing material in the embedded tag introduces a larger total amount of water near the tag antenna. At 90% RH the half-open and embedded tag shows about the same difference to the totally open reference tags.

There may be similarly showed the difference in power reflected back to the reader for the semi-active system. The semi-active tag, which is not sensitive to behind-laying background material, is characterized for 5 and 10 sheets of blotting paper respectively in front of the tag. Interestingly, the semi-active tag actually produces a stronger reflected power at higher levels of humidity than the same tag left open. The phenomenon of increased backscattering is possibly because the tag's impedance gets even closer to perfect matching than the original tag antenna. Introduced ohmic losses would then have smaller effect than the increase in impedance match. The different start values for the semi-active system also shows a difference in backscattered signal strength between open and covered tag already for dry papers. The sensitivity of a semi-active sensor system must therefore be even higher than the absolute values corresponding to a passive sensor system. At 50% RH the tag covered with 5 mm of paper for example backscatters about 1.5 dB stronger than the same non-covered tag. At 90% the same tag backscatters about 4 dB stronger than the non-covered tag. The “difference in difference” is thus only 2.5 dB. The same setup with the passive tags gives a difference from 0 dB to about 5 dB, making the readout more reliable.

The semi-active system was also characterized with another type of paper material as moisture concentrator. A long-fibered material specially developed to absorb moisture and expand in size while absorbing. Alternative material may give similar results as the blotting paper.

### IV. Characterization of Wet Tags

While the previous section characterized power differences for relative humidity level this section characterize the same labels for situations of real wetness. The real life comparison could be if the labels are put in locations inside walls and floors where there is a risk of water leakage. For example from leaking water pipe connections. This experiment was conducted in an ordinary RF lab, but still not within an anechoic chamber. The same kind of labels as in previous section were each placed 1.0 m (passive tags) and 1.61 m (semi-active tags) from each others respective RFID reader.

Water is added 1 gram at the time with aid of a pipette. It was found that the 103×20×5 mm covering the passive tags could receive about 10 grams of water before saturation of the paper itself. That is, after about 10 grams of water the stack of paper sheets cannot absorb any more but additional water flows away. A tag embedded with 5 mm paper on each side also wasn't readable at all at 1.61 m when it received more than 12 grams of water. At the time of malfunction the difference in transmitted power was about 13 dB. It is also observed that the difference in minimum transmitted power is almost linear to the amount of water added. Even though the totally embedded tag shows greater difference than the tag covered only on one side the difference for small amounts of water is not significant.

The water is added at an average of 5 drops per gram, distributed over the sheets. The amount of water versus power difference should be compared with the results from the climate room presented in accordance with what is depicted above. It was measured that 5 mm of paper at 90% RH differed 0.6 grams compared to the same pile of papers in 50% humidity. There may be showed a difference of about 5 dB for 90% humidity while another set up only shows about 1 dB for 0.6 grams. This could be a sign that the more evenly distributed the water is, the more influence it has on the tag antenna.

Looking at the results from a semi-active system, the increase in difference for small amounts of water may be recognized. When more water is added a positive difference is however observed. If neglecting the initial negative values, the differences for the semi-active labels are slightly smaller than for the passive system. It should however be remembered that the semi-active tag is covered by paper sheets of larger area than the passive tags since the tags themselves are larger, but are still compared with the same amount of water.

To see what actually happens with the tag antenna's input impedance, the experiment with adding water to a passive tag's cover was repeated with a tag has had its chip removed. The tag antenna was equipped with 5 mm paper on one side and its input impedance was measured with a standard network analyzer setup using an unbalances probe. There may be showed the tag's input impedance when the paper stack is dry, and has received respectively 4 and 10 grams of water. Operating frequency is indicated and it is observed that it doesn't move that much for 4 grams of water but moves significantly when 10 grams is added to the paper. In the Smith diagram, the impedance circles near the original input impedance get larger for larger amount of water.

### V. Conclusion

The concept of using pairs of ordinary RFID tags as differential moisture sensors has been presented and evaluated. The presented solution allows for remote reading of humidity and wetness levels inside for example walls and floors. The differences in power levels for different levels of relative humidity showed to be in the order of a couple of decibels for the 80% RH where humidity might start to be the source of mould. This puts hard constraints on the tolerances of the readout electronics and that the individual tag antennas within the label are not externally distorted by small variations in their respective vicinities. Even though one alternative paper material was tried in this investigation, future experiments could perhaps include materials that change their dielectric properties even more when exposed to moderate humidity levels. The total thickness of the absorbing material should preferably be as thick as possible to introduce largest electrical distortion in the tag antenna when wet. Hysteresis of paper material can also be a problem since a short increase can make an incorrect reading due to memory effects. However, an incorrect reading due to hysteresis however still indicates that the humidity level has been high.

The investigated semi-active system presented a potential problem as humidity sensor as the covered tag actually backscattered a stronger signal than the open tag. Decreasing signal strengths was observed only after adding more than 4 grams of water. The semi-active tags can be read at much longer distance and thereby also through walls of more difficult materials.

Using the passive tags as pure wetness sensors proved to show great performance in terms of power level differences as a few grams of water within the absorbing material gave difference of about several dBs.

A more advanced label could include 3 or more tags where perhaps one tag could have its antenna completely dissolved if moisture exceeds a certain value. This could for example be accomplished by having a water based electrically conductive ink (i.e. silver ink). In that way one would create a memory effect that tells the relative humidity have been above a certain level and also give the current value.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

The invention claimed is:

1. A sensor arrangement suitable for determining a condition, the sensor arrangement comprising:
a first RFID-unit and a second RFID-unit being subjected to said condition, wherein the second RFID-unit comprises a degradation unit having such properties that, when subjected to said condition, the second RFID-unit is functionally degraded to a greater extent than the first RFID-unit.

2. The sensor arrangement according to claim 1, wherein the degradation unit comprises a substrate including at least one of paper, fabric, plastics, or wooden material.

3. The sensor arrangement according to claim 1, wherein the second RFID-unit is substantially embedded within the degradation unit.

4. The sensor arrangement according to claim 1, further comprising:
a support arranged to support the first RFID-unit and the second RFID-unit.

5. The sensor arrangement according to claim 4, wherein said support comprises a fastener configured to attach said arrangement to an object.

6. The sensor arrangement according to claim 1, wherein the first RFID-unit and the second RFID-unit are arranged relative to each other such that, when activated, interference between said first RFID-unit and said second RFID-unit is at an acceptable level.

6. (canceled)

7. The sensor arrangement according to claim 1, wherein said condition comprises at least one of the following: moisture, temperature, pressure, or chemical contamination.

8. A sensor arrangement product, comprising:
a set of sensor arrangements according to claim 1, said set of sensor arrangements being removably connected to each other.

9. The sensor arrangement product according to claim 8, wherein said set of sensor arrangements are arranged in an N×M-matrix configuration, N and M being positive integers.

10. The sensor arrangement product according to claim 9, wherein the N×M-matrix is an N×1-matrix.

11. A method for determining a condition, the method comprising:
determining a difference in performance of a first RFID-unit and a second RFID-unit, said first RFID-unit and said second RFID-unit being subjected to said condition, the second RFID-unit being functionally degraded to a greater extent than the first RFID-unit due to said condition; and
establishing said condition on the basis of said determined difference.

12. The method according to claim 11, wherein determining the difference comprises determining a difference between a first response signal generated by the first RFID-unit and a second response signal generated by the second RFID-unit.

13. The method according to claim 11, wherein the difference between the first response signal and the second response signal is based upon the amplitude of said signals.

14. The method according to claim 11, wherein determining the difference comprises determining the difference between the activation energy of the first RFID-unit and the activation energy of the second RFID-unit.

15. The method according to claim 11, further comprising:
presenting and/or storing the established condition.

16. A communication device for determining a condition, the communication device comprising:
a communication unit configured to communicate with a sensor arrangement according to claim 1, and
a calculating unit configured to calculate a difference in performance of the first RFID-unit and the second RFID-unit, and
a unit configured to establish said condition.

17. The communication device according to claim 16, further comprising:
a unit configured to determine a difference between a first response signal generated by the first RFID-unit and a second response signal generated by the second RFID-unit.

18. The communication device according to claim 16, further comprising:
a unit configured to determine means for determining the difference between the activation energy of the first RFID-unit and the activation energy of the second RFID-unit.

19. The communication device according to claim 16, further comprising:
a unit configured to present and/or store the established condition.

20. The communication device according to claim 16, further comprising:
a unit configured to determine the distance between the communication device and an object, and/or
a unit configured to optically identifying information provided at an object.

21. A system, comprising:
a sensor arrangement according to claim 1, and
a communication device comprising a communication unit configured to communicate with the sensor arrangement, calculating unit configured to calculate a difference in performance of the first RFID-unit and the second RFID-unit, and a unit configured to establish said condition.

22. (canceled)

23. The method for manufacturing a sensor arrangement product according to claim 8, further comprising:
printing on a substrate with a printing press the sensor arrangement comprising a set of sensor arrangements each comprising a first RFID-unit and a second RFID-unit being subjected to said condition, wherein the second RFID-unit comprises a degradation unit having such properties that, when subjected to said condition, the second RFID-unit is functionally degraded to a greater extent than the first RFID-unit, said set of sensor arrangements being removably connected to each other.

24. A computer program product, comprising:
a computer readable medium; and
computer readable instructions recorded on the computer readable and executable by a processor for performing a method comprising determining a difference in performance of a first RFID-unit and a second RFID-unit, said first RFID-unit and said second RFID-unit being subjected to said condition, the second RFID-unit being functionally degraded to a greater extent than the first RFID-unit due to said condition, and establishing said condition on the basis of said determined difference.

25. (canceled)

26. (canceled)

27. The sensor arrangement according to claim 1, wherein the first RFID-unit and the second RFID-unit are arranged relative to each other such that said first RFID-unit and said second RFID-unit are subjected to substantially the same condition.
